(19) United States
(12) Patent Application Publication
(10) Pub. No.: US 2013/0112863 A1
(43) Pub. Date: May 9, 2013

(54) GENERATION OF HARMONICS IN OSCILLATION MASS SPECTROMETERS

(71) Applicant: Bruker Daltonik GmbH, Bremen (DE)

(72) Inventor: Claus Koster, Lilienthal (DE)

(73) Assignee: Bruker Daltonik GmbH, Bremen (DE)

(21) Appl. No.: 13/672,181

(22) Filed: Nov. 8, 2012

(30) Foreign Application Priority Data
Nov. 8, 2011 (DE) 102011118052.8

(51) Int. Cl. H01J 49/00; H01J 49/34

(52) U.S. Cl. CPC H01J 49/0036; H01J 49/34
USPC 250/282; 250/290

(57) ABSTRACT

The invention relates to measuring cells and measuring methods in oscillation mass spectrometers in which clouds of the same species of ion oscillate harmonically in a potential well in a longitudinal direction, decoupled from their motion transverse to this direction. A frequency analysis of the longitudinal oscillations of these ion clouds, which is carried out by a Fourier analysis of the induced image currents between two detection electrodes, leads to frequency spectra of the ions and hence to mass spectra. The position of the ion trajectories relative to the detection electrodes and the design of the measuring cells in the oscillation mass spectrometers is used to generate large proportions of harmonics in the image currents, and evaluate the frequency signals of the harmonics. The frequency signals of these harmonics have a higher resolution in the frequency spectrum (and hence in the mass spectrum), and allow resolution of the signals from ionic species of very similar mass which are not resolved in the fundamental oscillation. The accuracy of the mass determination increases proportionally

### PRIORITY INFORMATION

This patent application claims priority from German Patent Application No. 10 2011 118 052.8 filed on Nov. 8, 2011, which is hereby incorporated by reference in its entirety.

### FIELD OF THE INVENTION

The invention relates to measuring cells and measuring methods in oscillation mass spectrometers in which clouds of the same species of ion can oscillate harmonically in a potential well in a longitudinal direction, decoupled from their motion transverse to this direction. A frequency analysis of the longitudinal oscillations of these ion clouds, which may be carried out by a Fourier analysis of the induced image currents between two detection electrodes, leads to frequency spectra of the ions and hence to mass spectra.

### BACKGROUND OF THE INVENTION

In the past, only ion cyclotron resonance mass spectrometers (ICR-MS) were considered to be Fourier transform mass spectrometers (FT-MS). They record the mass-specific cyclotron motions of the ions via their image currents in suitable detection electrodes and convert them by a Fourier transform of the image current transients into a spectrum of the cyclotron frequencies. The frequency signals of these spectra are converted into mass signals of a mass spectrum by mathematical transformation functions. Calibration constants are incorporated into the transformation function to take account of distortions to the frequency spectra caused, for example, by superimposed magnetron motions.

However, it has since become known that there are a range of mass spectrometric principles which allow harmonic oscillations of ions to be used to produce mass spectra, and which use Fourier analyses for determining the oscillation frequencies. These principles are distinguished by the fact that ions of a specific cloud formation are stored in a suitable measuring cell in two spatial directions by centripetal forces making the ions oscillating or orbiting, and that the ion clouds oscillate freely in the third spatial direction in a harmonic potential. The centripetal forces that store the ion clouds in the first two spatial directions can be magnetic fields, RF-generated pseudopotentials or centripetal electrostatic fields between central electrodes and outer shell electrodes. The first two spatial directions are usually called “transverse directions r or y, x”, while the third direction, in which the ions oscillate harmonically, is called the “longitudinal direction z”.

In contrast to ICR mass spectrometers, these “oscillation mass spectrometers” do not detect an orbiting cyclotron motion of the ion clouds, but the back and forth oscillating motion in a harmonic potential in the z direction. The ions of different mass each oscillate as coherent and cohesive ion clouds in the longitudinal direction, but with different frequencies. The oscillations of the ion clouds can be measured in the form of induced image currents with suitably mounted detection electrodes. The measurement is carried out by a very sensitive amplifier with subsequent digitization of the measured values. A Fourier analysis of the temporal sequence of these digitized image current values, the so-called “image current transient”, results in the spectrum of the oscillation frequencies which occur in a mixture of oscillating ion clouds. The Fourier analysis is essentially carried out as a fast Fourier transform (“FFT”) of the digital values of the image current transient from the time domain into the frequency domain.

The generation of image currents in the detection electrodes by the ion clouds flying past is a complex process, which is easiest to visualize as the generation and shifting of mirror charges in the detection electrodes. The mirror charge is an aid to understanding the capacitively induced charge distribution on the surface of the detection electrodes. Usually two detection electrodes are used; the image currents measured are the integral currents between these two detection electrodes due to the motion of the surface charges induced by the oscillating ion clouds. The strength of the induced surface charge and its distribution depend on the proximity of the ions to the detection electrode and the shape and size of the detection electrodes.

A harmonic potential is characterized by the fact that a field is created which drives the ions deflected from the center back to the center again with a force proportional to the distance from the center. This condition is fulfilled when the potential has a minimum in a center and increases as a perfect parabola outside the center in the direction of the oscillation. The potential well of all oscillation mass spectrometers must always have a very good hair ionic form in the longitudinal direction so that the oscillation frequency is independent of the amplitude of the oscillating ions. If this were not the case, the ions of a spatially extended cloud would very quickly spread out and lose their coherence. If the ion clouds fill the whole space for oscillation, an image current is no longer produced. This would mean that the image currents of a spreading ion cloud would very rapidly decrease and it would not be possible to record long image current transients. A long image current transient of at least 100 milliseconds to several seconds in length is, however, crucial for a high resolution because the resolution is proportional to the number of detected oscillations.

The category of oscillation mass spectrometers includes the three-dimensional RF quadrupole ion traps operated with image current detectors, which are described in U.S. Pat. No. 5,625,186 (V. E. Frankevich et al.) (FIG. 1). FIG. 2 illustrates another embodiment which uses a stack of plates to generate a three-dimensional quadrupole field in which ions can oscillate (see U.S. Pat. No. 5,283,436). Ion cyclotron resonance mass spectrometers (ICR-MS) can also be operated as oscillation mass spectrometers if one succeeds in generating a precisely parabolic potential well in the direction of the magnetic field.

Oscillation mass spectrometers include the electrostatic Kingdon mass spectrometers, in which ions orbit around an inner electrode in an electric radial field, while at the same time oscillating in an electric potential well in a direction at right angles to this (FIG. 3). U.S. Pat. No. 5,886,346 discloses this type of Kingdon ion trap, marketed under the mark Orbitrap™ by Thermo-Fisher Scientific GmbH. The superimposed potentials are generated by two suitably designed electrodes, an inner spindle and an outer shell. The two motions, in the transverse direction and in the longitudinal direction are completely decoupled from each other if the electrodes are precisely shaped. These Kingdon ion traps are referred to as “Kingdon orbital ion traps” or “orbital traps” for short, in this description because the ions orbit around the inner electrode.

It is possible to design other oscillation mass spectrometers from the category of the electrostatic Kingdon ion traps, however. In particular, Kingdon ion traps can be designed so that the ions can oscillate transversely in a plane between one or more pairs of inner electrodes, as described in German Patent DE 10 2007 024 858 B4(C. Koster) and shown in FIG. 4 by way of an example. These ion traps are called “Kingdon oscillational ion traps”, or “oscillational traps” for short, in the text below.

The image currents induced in the detection electrodes of these oscillation mass spectrometers can contain harmonics because, although the oscillation motions of the ion clouds in the harmonic field must be strictly sinusoidal in temporal projection, the image currents they induce do not have to be. The image currents depend on the distance between the ion clouds and the detection electrodes, the speed of the ion clouds, and the shape and size of the detection electrodes. Depending on the geometric arrangement and shape of the detection electrodes, and the position and proximity of the ions flying past, the image current of a harmonically oscillating ion cloud can deviate from a sinusoidal oscillation and thus contain more or fewer harmonics, which show up in the Fourier analysis. In “good” oscillation mass spectrometers, the harmonics in the spectrum can hardly ever be seen because one generally attempts to avoid, or at least minimize, these harmonics. The harmonics make the spectrum more complex and interfere with the evaluation, although they provide higher resolutions than the fundamental oscillation. U.S. Pat. No. 7,888,633 B2 (J. Franzen) describes how residual harmonics in the frequency spectra can be located and removed. The harmonics are also termed “higher harmonic oscillations”, the first “harmonic” (double frequency) being termed the “second harmonic oscillation”.

Oscillation mass spectrometers require a very good high vacuum so that, during the measuring period, the harmonically oscillating ion clouds do not diverge diffusely as the result of a large number of collisions. They furthermore require good ion injection conditions so that they can be captured in suitably shaped ion clouds. Injection methods into Kingdon ion traps are described in U.S. Patent Application Publication 2010/0301204 (C. Koster and J. Franzen). A characteristic feature of oscillation mass spectrometers is a high mass resolution in the order of R=m/dm=50 000 for ions with a mass-to-charge ratio m/z=1000 atomic mass units, where m is the mass and Δm the full width at half-maximum of the mass signal. Depending on the type of oscillation mass spectrometer, the resolution decreases roughly as the reciprocal of the mass-to-charge ratio m/z (for oscillations in pseudopotential wells), or as the reciprocal of the square root of the mass m/z (for oscillations in real potential wells). Despite this decrease in the resolution towards higher masses, they are preferably suitable for the investigation of larger organic molecules because, in principle, they have no upper mass limit. Larger organic molecules are generally ionized by electrospray ionization (ESI) or matrix-assisted laser desorption (MALDI). Electrospray ionization generates the ions by protonating the molecules of the substance under analysis; as a rule, not only singly charged ions but also large numbers of multiply charged ions are generated, the latter being generated by multiple protonation. As a rule, MALDI essentially produces only singly protonated ions.

In ICR-MS, the image currents of the ions orbiting on cyclotron orbits are measured with the aid of two opposing longitudinal electrodes which, together with two excitation electrodes, form a cylinder with several longitudinal divisions. There have been several attempts to increase the resolution of this ICR-MS by using not two, but four, six or even eight detection electrodes. The ions flying past then result in a twofold, threefold or fourfold frequency, and thus a correspondingly higher resolution. Most of the attempts so far have been unsuccessful, probably because the coherence of the ion clouds could not be maintained sufficiently well. There is a need for an improved oscillation mass spectrometer with a measuring cell in which ion clouds can oscillate harmonically.

In mass spectrometry, it is never the mass which is determined but always the ratio of mass m to the number z of excess charges of the ions under analysis. It is thus always the “charge-related mass” m/z of the ions that is determined, where m is the physical mass and z the number of not compensated elementary charges of the ions. When one of the terms “mass of the ions”, “ion mass” or simply “mass” for short, is used here, this usually means the charge-related mass m/z.

### SUMMARY OF THE INVENTION

In a first aspect, the invention comprises using the position of the ion trajectories relative to the detection electrodes and the design of the measuring cells in the oscillation mass spectrometers to generate large proportions of harmonics in the image currents. The harmonics have a higher resolution in the frequency spectrum (and thus in the mass spectrum), and therefore allow resolving signals from ionic species of similar mass which are not resolved by the fundamental oscillation within a given measuring time. The accuracy of the mass determination also increases proportionally.

In Kingdon ion traps, the position of the ion trajectories is determined by, among other things, the location where the ions are introduced; the position can also be influenced by the operating mode, however.

In one aspect the invention comprises intentionally enhancing the harmonics, which are usually suppressed as efficiently as possible, compared to the fundamental oscillation by the operating mode and design of the oscillation mass spectrometers. The third harmonic oscillation produces a three times higher mass resolution, and the fifth harmonic even provides a five times higher mass resolution, for example. If a frequency resolution of R=50,000 is achieved for an ionic species in the fundamental oscillation, the third harmonic oscillation provides a resolution of R=150,000, and the fifth harmonic a resolution of R=250,000. The operating mode of the oscillation mass spectrometers, in particular the position of the ion trajectories in relation to the detection electrodes and the design of the oscillation mass spectrometers with their detection electrodes, can be utilized to deform the image currents for the image current transient in such a way that the third, or even the fifth, harmonic oscillation generates significant proportions of the frequency spectrum.

If the distortion between the position of the ion trajectories and the arrangement of the detection electrodes is symmetric, which is preferred here, harmonics occur which are odd multiples of the frequency of the fundamental oscillation. Frequencies thus occur with three, five and seven times the fundamental frequency. If the distortion is asymmetric, the even multiples of the fundamental frequency also occur, e.g., frequencies with twice, four times and six times the frequency of the fundamental oscillation.

In a second aspect, the invention comprises methods for identifying and evaluating the frequency signals of the harmonics. The signals of harmonics can be mistaken for the signals of multiply charged ions, especially if the whole isotope group of an ion type is not considered together in each case. The signals of the harmonics can be recognized by the greater separations between the isotopic peaks; but in order to recognize the signals of harmonics with certainty, each frequency signal is examined to establish whether it has associated harmonics or whether it is itself a harmonic of a frequency signal that is present as a fundamental oscillation. In order to identify the signals as harmonics with certainty, the signals of the other ions of the same isotope group must then be used in addition. These isotope signals have different separations compared to the signals of multiply charged ions, for the same width, but must possess the same signal height ratios as the isotope signals of the ions in fundamental oscillation. It is expedient to acquire an instrument-specific spectrum of the harmonics (the “sound spectrum” of this instrument in this operation mode, so to speak), and to use the knowledge of the signal height ratios between the harmonics to provide further certainty for the identification. This method of certain identification, and thus the use of harmonics also, can be performed automatically by computer programs.

After all the signals have been classified as fundamental oscillations or harmonics, it is possible to use mathematical filtering to generate frequency spectra which contain only the harmonics of the n-th order. If they stand out sufficiently from the noise, these frequency spectra exhibit an n-fold resolution and allow a mass determination which is n-times more accurate.

These and other objects, features and advantages of the present invention will become more apparent in light of the following detailed description of preferred embodiments thereof, as illustrated in the accompanying drawings.

### BRIEF DESCRIPTION OF THE DRAWING

FIGS. 1 to 4 are schematic representations of various prior art embodiments of oscillation mass spectrometers with a harmonic potential in one spatial direction, which differ in the way they store ions by radial forces in the other two spatial directions. The arrangements in FIGS. 1 and 2 use pseudopotentials generated by RF voltages as harmonic potentials for the mass-specific oscillations whereas, in FIGS. 3 and 4, electrostatic potential wells are available for the oscillations.

FIG. 1 illustrates a three-dimensional ion trap whose end caps 30, 31 enclose two image current detectors 33, 34 at their center. An RF voltage at the ring electrode 32 stores the ions. The stored ion clouds can be made to oscillate by different types of excitation pulses at the end cap electrodes 30, 31. The ion clouds 35, 36 and 37, with ions of different mass, then oscillate to and fro in the z direction between the end caps 30 and 31, and the image currents of their oscillations in the image current detectors 33 and 34 can be recorded by a measuring system.

FIG. 2 illustrates a three-dimensional ion trap constructed as a stack of individual diaphragms 41-45. In the interior of the stack an empty double cone has been cut out of the diaphragms; a quadrupole field can be generated in this double cone by applying the two RF frequency phases A×cos(ωt) and −A×cos(ωt) across the diaphragms, and this quadrupole field is essentially identical to the quadrupole field of the ion trap shown in FIG. 1. The ion clouds 48 can oscillate between the plates 41 and 45 in direction 49. The diaphragms 42 and 44 are at zero potential and can be used as image current detectors. The image currents can be amplified, digitized and processed further in the electronic unit 47.

FIG. 3 illustrates the measuring cell of a Kingdon mass spectrometer in which all the potentials are generated purely electrostatically. The ions are introduced through the aperture 13, and orbit on circular trajectories around a spindle-shaped center electrode 12 in an outer housing, which comprises two hemispheres 10 and 11, and are thus radially trapped. The clouds orbiting in a circle 14 then oscillate to and fro in the longitudinal direction and generate helical motion patterns. The outer electrode, which is divided at the center into the two hemispheres 10 and 11, is used as the image current detector.

FIG. 4 shows the measuring cell of a Kingdon mass spectrometer. The ion clouds 6, introduced through an aperture 5 in the hemisphere 1, oscillate to and fro in a plane between the two inner electrodes 3 and 4, and at the same time oscillate harmonically in the longitudinal direction. The image currents which are induced by the ion clouds (6) and which flow between the two outer housing electrodes 1 and 2 are measured and digitized.

FIGS. 5 and 6 show how the position of the ion trajectories within the Kingdon ion trap can be changed by altering the operating method. In comparison to the ion trajectories in FIG. 5, the oscillation amplitudes of the ion clouds 6 are reduced in the plane between the two inner electrodes 3 and 4 because, after the ions were introduced, the voltage between inner and outer electrodes was increased. The ion trajectories of FIG. 6 generate fewer harmonics in the image currents than the ion trajectories of FIG. 5.

FIGS. 7 and 8 show how the position of the ion trajectories can be changed by the choice of position of the introduction aperture 5. FIG. 7 also shows how the image currents can be measured with the aid of the two parts 3a and 3b of the split inner electrodes, which results in considerably more harmonics in the image currents. The second inner electrode 4 is not visible in the drawing, but its position in front of the inner electrode 3 is shown in FIG. 4. This second inner electrode 4 should also be split and participate in the measurement.

FIGS. 9 and 10 show how the position of the ion trajectories relative to the detection electrodes can be changed by altering the shape of the inner and outer electrodes. With the slimmer form of the Kingdon ion trap according to FIG. 9, the outer housing is, furthermore, split into four detection electrodes 1, 7, 8 and 2, which can be used in different ways for the measurement. If only the detection electrodes 7 and 8 are used, more harmonics are generated in the image currents. If the electrodes 1 and 8 and the electrodes 2 and 9 respectively are connected together and used in this way to measure the image currents, double the oscillation frequency of the ion clouds is measured as the fundamental frequency; there are also harmonics of this fundamental frequency.

FIG. 11 shows schematically how a change in the image current curves of an ion cloud affects its frequency spectrum (bottom). If an ion cloud generates a pure sinusoidal oscillation of the image current (top), then two ion clouds with ions of very similar mass only produce the peak group A of the frequency spectrum, which contains two unresolved superimposed signals. In contrast, if the image current curve induced by an ion cloud is distorted, as shown in the center of the illustration, the two ion clouds of similar mass resolution produce a spectrum with the additional harmonic peak groups B, C and D of the third to seventh order, and a significantly higher frequency, as can be seen from the enlargement of the signal separations from a to 7a.

FIG. 12 shows a measured frequency spectrum of doubly charged ions of bombesin with harmonics of the third and fifth order, acquired in the oscillational trap according to Koester, as shown in FIG. 4. The resolution for the fundamental oscillation is R_{ω,1}=35,000 here; the harmonics of the third and fifth order provide resolutions of R_{ω,3}=105,000 and R_{ω,5}=175,000.

### DETAILED DESCRIPTION OF THE INVENTION

Aspects of the present invention comprise effecting strong harmonics in the image currents of oscillation mass spectrometers and using them for an improved mass separation and mass accuracy. In the frequency spectrum, these harmonics have a frequency ω which is several times higher and thus a several times higher frequency resolution R_{ω}=ω/Δω at the same full width at half-maximum (FWHM) Δω. They therefore allow resolution of the signals from ionic species of similar mass which are not resolved in the fundamental oscillation, as is schematically shown in FIG. 11. The higher resolution is also maintained in the mass spectrum. With higher mass resolution, the accuracy of the mass determination also increases proportionally.

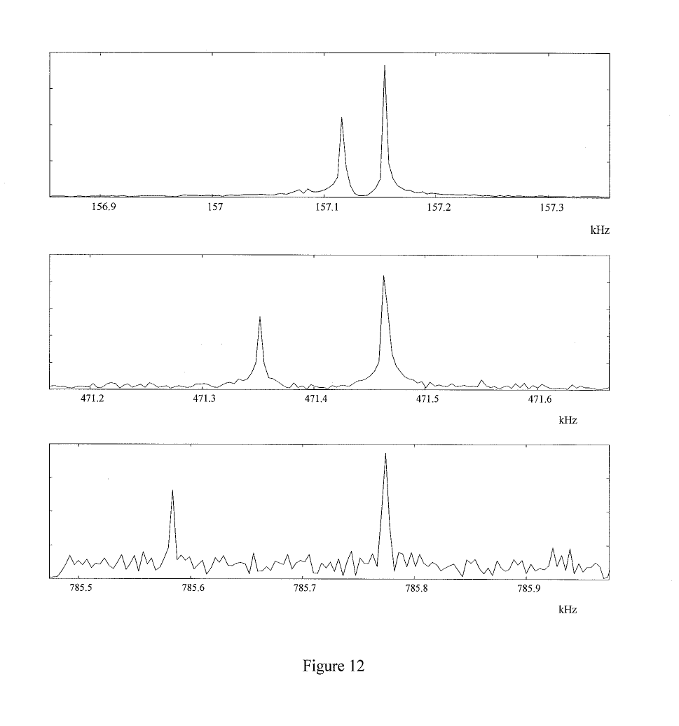

An aspect of the invention therefore comprises intentionally enhancing the harmonics, which are usually suppressed as efficiently as possible, compared to the fundamental oscillation. The harmonics are enhanced by the operating mode and design of the oscillation mass spectrometers. In one embodiment, the third harmonic oscillation exhibits a three times higher mass resolution, and the fifth harmonic even exhibits a five times mass resolution. If a resolution of R=35,000 is achieved in the fundamental oscillation for an ionic species, as can be seen in FIG. 12 with a measurement of the doubly charged ions from bombesin, the third harmonic oscillation provides a resolution of R=105,000, and the fifth harmonic a resolution of R=175,000. The measurement was carried out in a Kingdon mass spectrometer according to FIG. 4.

In the following, more detailed descriptions are provided with the example of Kingdon mass spectrometers according to FIG. 4, i.e., for oscillatory Kingdon ion traps. This restriction should not limit the invention to this type of oscillation mass spectrometer, however.

An increased occurrence of harmonics in the image currents can be achieved by changing the position of the trajectories of ion clouds relative to the detection electrodes, as shown for example in FIGS. 5 to 10. Changes in the shape of the detection electrodes can also contribute to the harmonics. FIG. 7 depicts, for example, how split inner electrodes 3a and 3b can be used for the measurement of image currents with a high proportion of harmonics; FIG. 9 shows a housing which is split into four detection electrodes 1, 7, 8 and 2. Changed operating modes of the oscillation mass spectrometer can force positional shifts in the ion trajectories in relation to the detection electrodes. Combinations of these measures can achieve that the third, or even the fifth, harmonic oscillation fauns relatively large proportions of the frequency spectrum. The odd-order harmonics result from symmetric changes of the position of the ion trajectories in relation to the detection electrodes. If the changes are asymmetric, the even multiples of the fundamental frequency also occur, e.g., frequencies with twice, four times and six times the frequency of the fundamental oscillation. If asymmetric changes are avoided, the even-order harmonics cannot be observed. With multiply split detection electrodes, it is also possible to generate double fundamental frequencies.

The harmonics should not be generated by a non-harmonic distortion of the longitudinal oscillations, because then the coherence of the ions in the ion clouds is lost rapidly. The potential well should maintain a parabolic form in the longitudinal direction.

The intentional generation of harmonics is similar to the attempt to measure higher frequencies in the ICR-MS by increasing the number of detection electrodes, but is significantly more successful in practice. Higher frequencies can, however, also be generated in oscillation mass spectrometers by the multiple division of the detection electrodes, as shown in FIG. 9.

The generation of image currents in the detection electrodes by the ion clouds flying past is a complex process, which is usually represented by the generation and shifting of mirror charges in the detection electrodes. As mentioned hereinabove, the mirror charge is an aid to understanding the capacitively induced charge distribution on the surface of the detection electrode for planar surfaces. The minor charge on a planar surface ensures that the electric field lines are perpendicular to the surface. In reality the mirror charge does not exist; a distribution of charges on the surface provides the perpendicular field lines; a conductive surface itself must be an equipotential surface, of course. An electric charge flying above the surface of two neighboring electrodes thus generates a shift, enhancement or attenuation of this charge distribution on the surfaces and thus generates an image current between the two adjacent electrodes to maintain the supply of charge.

Two detection electrodes are usually used; the image currents measured are the integral currents between these two detection electrodes due to the motions, enhancements and attenuations of the surface charges induced by the oscillating ion clouds. The induced surface charge and its distribution depend (quadratically) on the proximity of the ions to the detection electrode and the shape and size of the detection electrodes. If, for example, an ion cloud oscillates to and fro close to two detection electrodes, and if the oscillation amplitude of the ion cloud is much greater than its vertical distance from the detection electrodes, as is particularly the case in the arrangement according to FIG. 7, there will be hardly any current as long as the ion cloud moves only above one of the two detection electrodes in a far distance from the gap. Only when the ion cloud crosses the gap on returning from its oscillation, is there a current pulse of the image current. The image current curve is thus very different from a sinusoidal curve and, when analyzed, it displays large proportions of harmonics. If, on the other hand, the distance of the oscillating ion cloud from the detection electrodes corresponds approximately to its oscillation amplitude, an approximately sinusoidal image current curve is generated. This situation is shown in FIG. 6, where the trajectories of the ion clouds after the introduction of the ions were shrunk by increasing the voltage between inner electrodes and housing electrodes; there are hardly any harmonics of the image currents here. With this simple knowledge, a device for generating image current transients which are particularly rich in harmonics can be designed, either in simulations or by suitable experiments. In particular, the detection electrodes can be designed in such a way that they do not cover the full oscillational amplitude of the ion clouds, just like the detection electrodes (7) and (8) in FIG. 9. This measure also contributes to the enhancement of harmonics.

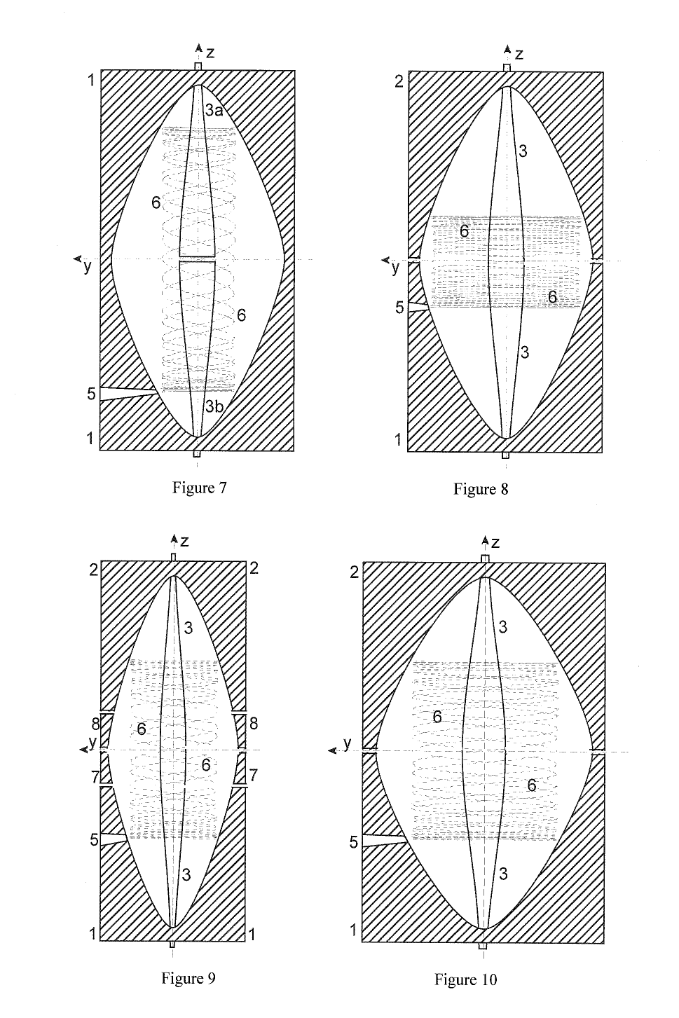

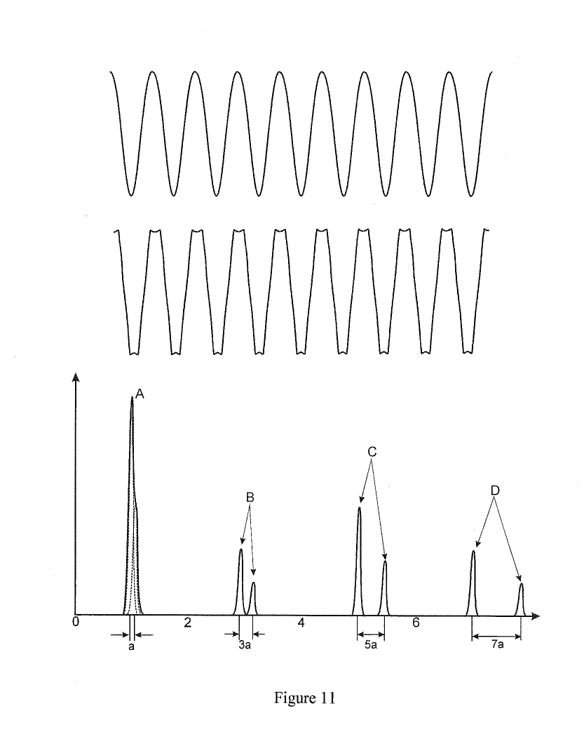

The position of the aperture for the introduction of the ions can also influence the harmonics content of the image currents. Two examples are shown in FIGS. 7 and 8. The Kingdon ion traps can also have a slimmer or fatter shape, as depicted in FIGS. 9 and 10; these changes in shape also affect the harmonics content. FIG. 9 shows a slim Kingdon ion trap, whose outer electrode is split into four sections 1, 7, 8 and 2. If only the detection electrodes 7 and 8, or only the electrodes 1 and 2, are used for the detection, large proportions of harmonics are obtained. If the electrodes 1 and 8 and the electrodes 7 and 2 respectively are connected together and the current is measured between these pairs of electrodes, then essentially twice the oscillation frequency of the ions is measured, in addition to harmonics of this double frequency.

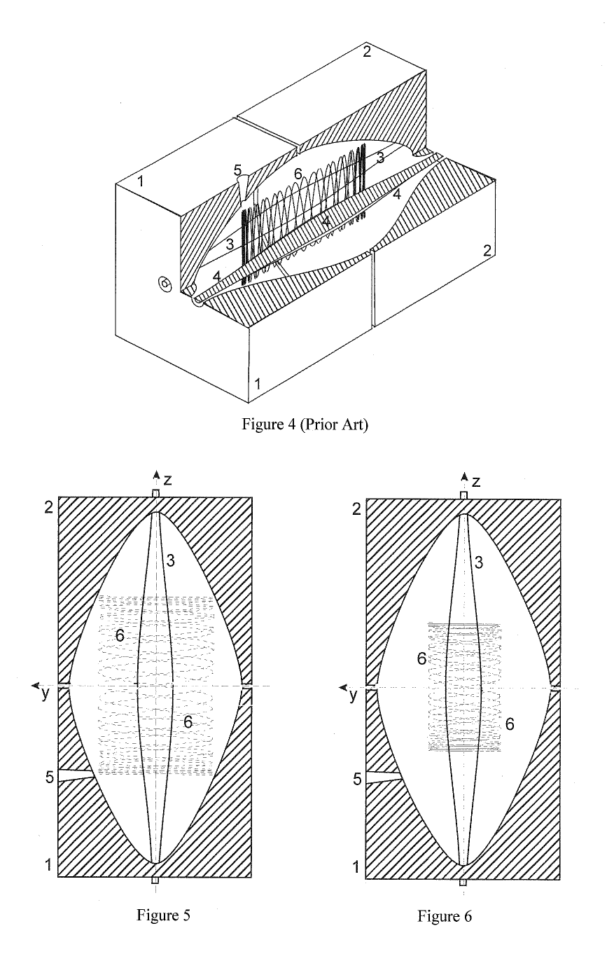

Particularly large proportions of harmonics in the frequency spectra are obtained if split inner electrodes rather than split outer electrodes are used as detection electrodes in Kingdon ion traps, as shown in FIG. 7. It is possible, for example, to operate the ion traps according to FIGS. 3 and 4 in such a way that the inner electrodes are at ground potential and the outer housings at high voltages. It is then particularly easy to use split inner electrodes 3a and 3b as image current detectors and to measure the image currents between the detection electrodes. The high proportions of harmonics arise because the ion clouds near the gap between the detection electrodes are closest to them and they cross the gap very quickly, thus resulting in a drastic, short-term change in the image current when the ion clouds fly past the gap in their longitudinal oscillation. The temporal curve of the image current of an oscillating ion cloud is therefore very different from the form of a sinusoidal oscillation and contains large proportions of harmonics.

If signals of harmonics occur in the frequency spectra, they can sometimes, if viewed uncritically, be mistaken for the signals of multiply charged ions, as are produced by electrospray ionization (ESI), for example. The signals of the harmonics have the same width as the signals from ion clouds in fundamental oscillation with similar frequency. But the signals of the harmonics can be recognized by their better resolution, e.g., by significantly larger separations of the signals of an isotope group; nevertheless, in order to recognize the harmonics with certainty, it is expedient to examine each frequency signal to establish whether it has associated harmonics or whether it is itself a harmonic of a frequency signal that is present as a fundamental oscillations. The method is described in the document U.S. Pat. No. 7,888,633 B2, already cited above. The signals of the other ions of the same isotope group, which display separations several times greater than those of multiply charged ions, can also be used for the certain identification of the signals as harmonics. Furthermore, the signal intensities must have the characteristic pattern of the isotopic distribution for this molecule.

An instrument-specific and method-specific spectrum of the harmonics (the “sound spectrum” of this instrument in a special operation mode, so to speak) can be acquired with the oscillation mass spectrometer which was modified according to an aspect of this invention; and the knowledge of the signal height ratios of the harmonics with respect to each other can be used to provide further certainty for the identification. This method of certain identification, and thus the use of harmonics also, can be carried out automatically, e.g., by a computer. In particular, it is possible to use mathematical filtering to generate frequency spectra which contain only the harmonics of the n-th order. If they stand out sufficiently from the noise, these spectra exhibit an n-fold resolution and allow a mass determination that is n-times more accurate.

The relationships between the oscillation frequencies and the associated ion masses are known in principle for every oscillation mass spectrometer. This also applies to the harmonic frequencies. The transformation functions depend on the type of potential in which the ions oscillate, and thus on the type of oscillation mass spectrometer.

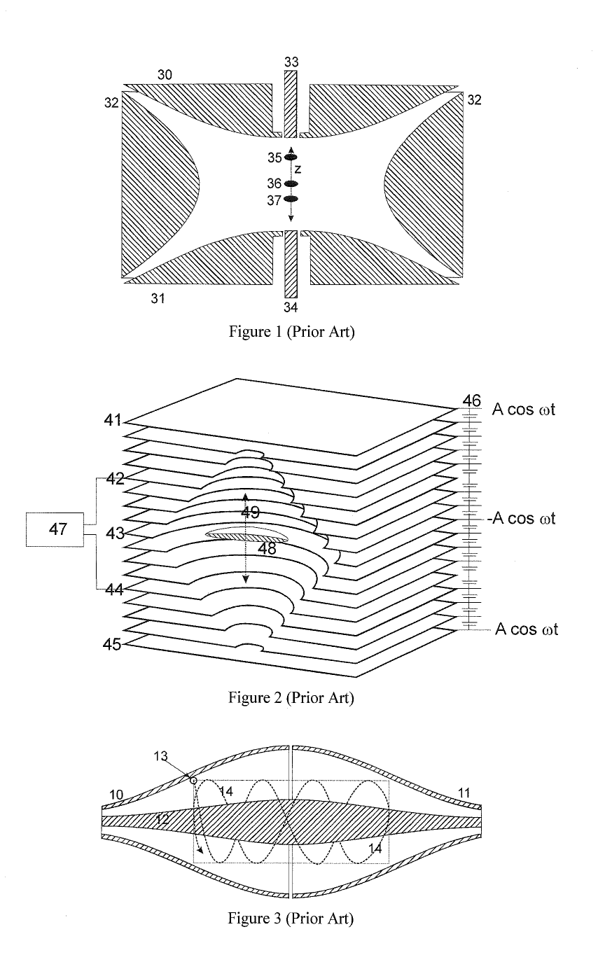

If the oscillations take place in RF-generated pseudopotentials (FIGS. 1 and 2), the masses are approximately reciprocal to the oscillation frequencies. There is no explicit analytical conversion formula here, but approximation equations derived from the Mathieu differential equations are known that allow as accurate a conversion as desired. With an uncritical conversion, the n-th harmonics provide apparent ion masses which are close to the charge-related masses m/z of the multiply charged ions with z=n, but do not exhibit a changed mass value due to multiple protonation.

In the case of oscillation mass spectrometers with electrostatic potentials (FIGS. 3 and 4), the ion masses are calculated as the reciprocal of the square of their oscillation frequency. In this case, the signals of the first harmonic, i.e., the second harmonic oscillation, can, if viewed uncritically, appear to be signals of quadruply charged ions, but without the masses of the additional three protons which are present in ions quadruply charged by protons, and with an expanded pattern of the isotope group. If these oscillation mass spectrometers are operated with ionization of the examined molecules by electrospray, then multiply charged ions always occur, and the harmonics may be overlooked. The electrospray ionization generates, for example, quadruply charged ions (m+4)⁴⁺ by quadruple protonation, where m is the mass of the molecule. The charge-related mass m/z of these ions is therefore (m+4)/4. The first harmonic of the singly protonated ions, on the other hand, supplies ion signals at the mass (m+1)/4, which is close to the masses of the multiply charged ions. But since the ions of organic molecules form an isotope group with three, four or five signals, whose ion signals each display a separation of one mass unit, analysis can rapidly ascertain whether harmonics occur. The risk of confusion is low: first, the signals of the harmonics can also be recognized by their significantly higher resolution, and second, harmonics of the second order occur only rarely. It is easy to avoid them. For higher harmonics, confusion is practically impossible.

Many types of oscillation mass spectrometer are conceivable, but only a few of them have been realized as yet. The oldest type of oscillation mass spectrometer is the Fourier transform ion trap, which is disclosed in U.S. Pat. No. 5,625,186 (V. E. Frankevich et al.) and was investigated roughly ten years ago in the research group of Prof Graham Cooks. The arrangement is shown in FIG. 1. It has never been used commercially because of significant difficulties in detecting the minute image currents in the presence of high RF voltages. The RF voltage of the ring electrode induces considerable RF voltages in the image current detector electrodes, and these must be cleanly filtered out. No harmonics have yet been found in these mass spectrometers.

The only commercially available oscillation mass spectrometer to date is the Orbitrap™ mass spectrometer from Thermo-Fisher, whose principle is shown in FIG. 3. This can be manufactured to such a high degree of precision and operated so that no measurable harmonics occur. Like all Kingdon mass spectrometers, this embodiment also has the advantage of not using RF voltages, which may interfere with the detection of the image currents. It is not yet known whether harmonics can be suitably generated in the image currents with this arrangement.

The list of oscillation mass spectrometers is not exhaustive; those skilled in the art can find further principles, especially principles which operate purely electrostatically. There will always be principles which contribute to enhancing the proportion of harmonics in the frequency spectra, so this invention can help to obtain mass spectra with very high mass resolution and mass accuracy.

Although the present invention has been illustrated and described with respect to several preferred embodiments thereof, various changes, omissions and additions to the form and detail thereof, may be made therein, without departing from the spirit and scope of the invention.

What is claimed is:

1. An oscillation mass spectrometer, comprising:
a measuring cell in which ion clouds can oscillate harmonically; and
a device comprising detection electrodes that measures image currents induced by the ion clouds in the measuring cell, wherein proportions of harmonics are generated in the image currents by the measuring cell with the detection electrodes and by the position of the ion trajectories in relation to the detection electrodes.

2. The oscillation mass spectrometer of claim 1, wherein the measuring cell is configured and arranged as a Kingdon ion trap that includes an outer housing and outer housing electrodes.

3. The oscillation mass spectrometer of claim 2, wherein one of the outer housing electrodes has an aperture for the introduction of the ions, and the aperture is positioned such that harmonics are generated in the image currents by the oscillating ion clouds.

4. The oscillation mass spectrometer of claim 2, wherein the outer housing of the Kingdon ion trap is split at right angles to the direction of the harmonic oscillations of the ion clouds into at least two electrodes, and the two electrodes operate as detection electrodes for the device for the measurement of the image currents.

5. The oscillation mass spectrometer of claim 2, wherein the inner electrodes of the Kingdon ion trap are split at right angles to the direction of the harmonic oscillations of the ion clouds and serve as detection electrodes for the device that measures the image currents.

6. The oscillation mass spectrometer of claim 4, wherein one of the outer housing or the inner electrodes are split into more than two detection electrodes.

7. A method for evaluating the frequency spectra which are obtained in an oscillation mass spectrometer that includes a measuring cell in which ion clouds can oscillate harmonically and a measuring device that includes detection electrodes, the method comprising:
measuring image currents induced by the ion clouds of the measuring cell using the detection electrodes, and generating harmonics in the image currents by the measuring cell with the detection electrodes and by the position of the ion trajectories in relation to the detection electrodes.

8. The method of claim 7, wherein, in order to recognize harmonics in the frequency spectra, analyzing the analyzed signals to ascertain whether there are associated signals which have a precisely integral fraction or a precisely integral multiple of the frequency.

9. The method of claim 7, wherein an instrument-specific reference spectrum of the harmonics is measured for an oscillation mass spectrometer, and the signal height ratios of the reference spectrum of the harmonics are used to identify a signal with certainty as a harmonic.

10. The method of claim 7, wherein all the signals of an isotope group are used to identify a signal with certainty as a harmonic.

11. The method of claim 10, wherein the signal height ratios within an isotope group are used to identify a signal as a harmonic.

12. The method of claim 7, wherein, after the recognition of signals as fundamental oscillations or harmonics, generating a frequency spectrum containing only signals of the harmonics of nth order, whereby a frequency spectrum is obtained with n-fold enhanced resolution.
